(19) United States
(12) Patent Application Publication
(10) Pub. No.: US 2024/0411286 A1
(43) Pub. Date: Dec. 12, 2024

(54) DETERMINING OBJECT CREATION INSTRUCTIONS

(71) Applicant: Hewlett-Packard Development Company, L.P., Spring, TX (US)

(72) Inventors: Helen BALINSKY, Bristol (GB); Craig Peter SAYERS, Palo Alto (GB)

(21) Appl. No.: 18/274,045

(22) PCT Filed: Feb. 5, 2021
(86) PCT No.: PCT/US2021/016722

§ 371 Date: Jul. 25, 2023

(51) Int. Cl. G05B 19/4099; H04L 9/00

(52) U.S. Cl. CPC G05B 19/4099; H04L 9/50; G05B 2219/49023

(57) ABSTRACT

In an example, a method is described. The method includes determining a cryptographically-derived content for a marking based on a blockchain ledger. The blockchain ledger comprises a record authorizing a manufacturing apparatus to create an object. The method further includes determining object creation instructions to create a modified version of the object comprising the marking. The manufacturing apparatus may create the modified version of the object according to the determined object creation instructions.

### BACKGROUND

An object may be created based on object creation instructions which specify how a manufacturing apparatus such as a three-dimensional printer is to create a specified object. A marking may be applied to the object to indicate certain information about the object such as its serial number.

### BRIEF DESCRIPTION OF DRAWINGS

Non-limiting examples will now be described with reference to the accompanying drawings, in which:

FIG. 1 is a flowchart of an example method of determining object creation instructions and creating an object;

FIG. 2 is a schematic drawing of an example system for implementing certain methods, machine-readable media and/or apparatus;

FIG. 3 is a signaling diagram depicting example methods implemented by a blockchain node and a manufacturing apparatus manager;

FIG. 4 is a flowchart of an example method for implementing functionality of a manufacturing apparatus manager;

FIG. 5 is a flowchart of an example method for implementing functionality of a blockchain node;

FIG. 6 is a flowchart of an example method for implementing functionality of a blockchain node;

FIG. 7 is a simplified schematic drawing of an example machine-readable medium associated with a manufacturing apparatus manager;

FIG. 8 is a simplified schematic drawing of an example apparatus associated with a manufacturing apparatus manager,

FIG. 9 is a simplified schematic drawing of an example machine-readable medium associated with a blockchain node; and

FIG. 10 is a simplified schematic drawing of an example apparatus associated with a blockchain node.

### DETAILED DESCRIPTION

It may be useful to monitor and/or control certain manufacturing parameters associated with, for example, when and/or where (e.g., by whom) a product is manufactured and/or a quantity of manufactured products. For example, a manufacturing parameter may refer to a product that is manufactured: at a certain location (e.g., an identity of a manufacturing facility); by a certain manufacturing apparatus (e.g., a specified type or identity of manufacturing apparatus); with a certain product quantity and/or within a certain time period.

The monitoring and/or control of certain manufacturing parameters may be useful for various stakeholders such as a product rights-holder (e.g., the original designer or a licensee), product distributor (e.g., a logistics firm, wholesaler, retailer, etc.), product servicer (e.g., a product finishing service, repairer, etc.) and/or product user (e.g., an end user). For example, a stakeholder may wish to ensure that an approved manufacturing apparatus is used to manufacture the product for various reasons such as quality control purposes. In another example, the product rights-holder and/or distributor may wish to reduce the possibility of unauthorized copies of the product entering the market, while the product servicer and/or product user may wish to obtain evidence that their product is genuine.

Digital tracking procedures which implement a blockchain platform may be used to record certain stages of the manufacturing and distribution process. For example, certain stakeholders may use such digital tracking procedures to increase confidence in the integrity of a supply chain.

A blockchain platform may comprise a blockchain client and a blockchain server (which is an example of a ‘blockchain node’, as referred to herein). Multiple blockchain clients and servers may be connected together as part of the blockchain platform. A blockchain server stores a ‘blockchain ledger’, which may comprise an immutable record of transactions (i.e., ‘records’ or ‘blockchain records’, as referred to herein) comprising information received from a blockchain client.

Certain rules implemented by the blockchain platform, which may be enforced as part of a ‘smart contract’, may manage the interaction between the different entities. For example, the rules may specify whether or not information received by a blockchain server can be recorded as a transaction in the blockchain ledger, as well as how the information is to be recorded. In another example, certain rules (i.e., a ‘consensus protocol’) may specify how information is shared between different blockchain servers. For example, multiple blockchain servers (i.e., each of which may be referred to herein as a ‘blockchain node’) may be connected together and each store a copy of the blockchain ledger.

In response to receiving a blockchain record request (e.g., comprising information about a manufacturing parameter) from a blockchain client, a blockchain node may validate the signature of the received transaction request and the corresponding ‘business’ rules. If the transaction request is valid, the request is added/written to the blockchain ledger at this particular node. Using a consensus protocol, blockchain nodes may share and propagate changes and come up with a blockchain ledger that is agreed upon by all parties. A new transaction recorded in the blockchain ledger may be cryptographically linked to a previous transaction in the blockchain ledger (e.g., via a cryptographic hashing function applied to at least part of the information in the previous transaction). The functionality of the blockchain platform may ensure that the information stored in the blockchain ledger is secure and immutable (i.e., cannot be changed undetected), which may increase stakeholder confidence in the manufacturing and/or distribution process.

In an example scenario, a manufacturer may create a record comprising information associated with manufacturing a product (e.g., a ‘manufacturing parameter’). Such information may include, for example, confirmation of completion of manufacture, date/time stamp associated with completion, product number and serial number of a manufactured product, identity of the manufacturing facility and/or identity of a manufacturing apparatus used to create the product. The manufacturer may instruct a blockchain client to submit the record to a blockchain node. Providing the business rules associated with the smart contract are satisfied, the record is written to the blockchain ledger.

A product rights-holder may instruct a blockchain client under their control to check information about the product or the manufacturing process by querying the blockchain ledger. For example, the query may check whether the manufacturing process has been performed as expected by inspecting the record submitted by the manufacturer.

Other example scenarios may refer to various actions taken by stakeholders such as querying the blockchain ledger and/or submitting records to be stored in the blockchain ledger, if permitted by the business rules. Depending on the result of the action, a stakeholder may ascertain whether or not there is a potential problem with the product itself, the manufacturing process and/or distribution of the product.

A manufacturing apparatus may execute object creation instructions (also referred to herein as ‘object manufacturing instructions’) to create an object. Object creation instructions may be based on a digital model (such as a computer-aided design) of the object, which has been interpreted (e.g., compiled) to form the object creation instructions for the manufacturing apparatus. The digital model may be interpreted in different ways depending on how the manufacturing apparatus creates the object and/or the identity of the manufacturing apparatus (e.g., the brand, brand model, build material used, etc.).

An example manufacturing apparatus may implement an additive manufacturing technique (e.g., such as a three-dimensional printer). Additive manufacturing techniques may generate a three-dimensional object through the solidification of a build material, for example on a layer-by-layer basis. In examples of such techniques, build material may be supplied in a layer-wise manner and the solidification method may include heating the layers of build material to cause melting in selected regions. In other techniques, chemical solidification methods may be used. Thus, an additive manufacturing apparatus may create, or ‘print’, an object in accordance with the object creation instructions.

Another example manufacturing apparatus may implement a material-removal technique for selectively removing material from a portion of a block of material to create an object in accordance with the object creation instructions. Examples of such manufacturing apparatus include: a computer-numerical control (CNC) milling machine, an etching apparatus (e.g., for controlling a chemical-based etching process), engraving apparatus, etc.

In these and other examples, a manufacturing apparatus may produce an object in accordance with the object creation instructions.

As used herein, an object may refer to a product or a part such as a label for integration with a product. The object may or not may be the ‘final’ product received by a customer. In some scenarios, a product may go through various manufacturing stages, potentially at different manufacturing locations, postprocessing, assembly, before it is sent to a product distributor for distribution to a customer.

Further stages of a supply chain may include finishing the product at a product servicer (e.g., for customization, software installation, etc.).

Thus, in some scenarios, the product may go through a potentially complex supply chain before being received by an end user of the product. The various transactions that take place in the supply chain may be recorded in the blockchain ledger and, if necessary, this information may be accessed by a stakeholder. If the end user sends the product to a product servicer for repair/upgrade, this ‘transaction’ and any other relevant information may be submitted to the blockchain ledger by the end user and/or product servicer.

Accordingly, in some scenarios, blockchain technology may be used to monitor and/or control a product during its entire lifecycle, or a part thereof. In some scenarios, blockchain technology may also be used to detect the presence of counterfeit/unauthorized products in the field.

In some examples, a product may comprise the object (e.g., the product may be the object itself or the product may be constructed of various parts and one of these parts may be the object). Thus, any reference to an object described herein may, where appropriate, also refer to a product.

In some examples, the object may comprise a marking. A marking may comprise information or a pointer to information (such as a weblink) about the object and/or the product comprising the object. Such information may include, for example, a product model, serial number and/or a manufacturing parameter associated with manufacture of the object and/or a product comprising the object.

A marking may be overt (e.g., visible on a surface of the object) or covert (e.g., the marking may be under the surface of the object, not externally visible, not visible to the human eye where special equipment is used to read the marking, etc.). A marking may be machine-readable and/or human-readable.

Examples of techniques for creating a marking include additive manufacturing techniques, as well as techniques for selective material removal. In some examples, the technique may itself be used to create the object as well as the marking. In some examples, the technique may be used to create the marking for the object (i.e., the object may be at least partially ‘pre-manufactured’ before the marking is created).

Various examples of techniques for creating a marking include: 3D printing, molding, adding a different build material to denote the marking (e.g., a different color build material, a different type of build material that is distinguishable from a surrounding build material, a build material comprising fluorescent particles, etc.), etching, engraving, etc.

The marking may be readable with or without specialized equipment (e.g., a scan reader, camera, microscope, X-ray vision, tomography, etc.).

As part of the manufacturing process, the manufacturing apparatus may create the marking as an integral part of the object or as a part for integration with a product (for example, by attaching the part to the product by embedding, adhering, etc.).

Various examples described herein may refer to determining content for such a marking, for example, based on a manufacturing parameter. In addition, various examples described herein may refer to creating an object comprising such a marking. In addition, various examples described herein may refer to utilizing a blockchain platform to monitor and/or control a manufacturing process and/or distribution of a product.

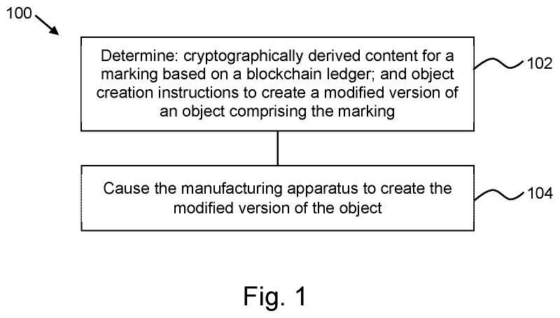

FIG. 1 depicts a flowchart of a method 100, which may be a computer-implemented method, of determining object creation instructions and causing an object to be created based on the object creation instructions. The method 100 may be implemented by processing circuitry of e.g., a manufacturing apparatus manager. The manufacturing apparatus manager may comprise a blockchain client.

A manufacturing apparatus manager may monitor and/or control a manufacturing apparatus. In an example, a manufacturing apparatus manager may be implemented by embedded software, firmware and/or hardware of a manufacturing apparatus. In other words, the manufacturing apparatus itself may implement certain methods described herein (e.g., including method 100 and other methods described below).

In another example, the manufacturing apparatus manager may be implemented by a computing device such as a server (e.g., implemented by software, firmware and/or hardware) that is communicatively coupled to the manufacturing apparatus. An example scenario based on this example may include multiple manufacturing apparatus being monitored and/or controlled by the same manufacturing apparatus manager.

Thus, any reference herein to an authorized manufacturing apparatus may also refer to multiple manufacturing apparatus under the control of an authorized manufacturing apparatus manager.

In some examples, a manufacturing apparatus may have its own cryptographic identity (e.g., based on a private-public key pair). In some examples, the manufacturing apparatus manager may have its own cryptographic identity (which is the public key from a private-public key pair). In such examples, the (e.g., at least one) manufacturing apparatus associated with the manufacturing apparatus manager may or may not have their own cryptographic identity. For example, within a manufacturing facility, there may be multiple manufacturing apparatus. Each manufacturing apparatus may have its own cryptographic identity (and each manufacturing apparatus may have its own associated manufacturing apparatus manager). However, in other examples, a manufacturing apparatus manager may monitor/control manufacturing by a set of manufacturing apparatus. In such examples, the manufacturing apparatus manager may have its own cryptographic identity and is trusted to monitor/control operation of each of the set of manufacturing apparatus (whether or not they have their own cryptographic identity).

The method 100 comprises, at block 102, determining cryptographically-derived content for a marking based on a blockchain ledger. The blockchain ledger comprises a record authorizing (i.e., an ‘authorizing record’) a manufacturing apparatus to create an object.

The manufacturing apparatus may be authorized, by an authorizing entity, to create the object. The authorizing record may be submitted, by the authorizing entity (i.e., a rights holder), to the blockchain ledger. The authorizing entity may refer to another blockchain client that is trusted to indicate which manufacturing apparatus is authorized to create the object. In some examples, the authorizing entity may be a design owner, license owner and/or an entity having the right to produce at least one copy of a product.

The record may comprise information identifying the manufacturing apparatus. In some examples, the identifying information may refer to a specified identity (e.g., a cryptographic identity) of an authorized manufacturing apparatus. In some examples, the identifying information may refer to an indication of a manufacturing apparatus associated with the manufacturing apparatus manager (e.g., any associated manufacturing apparatus).

The blockchain ledger may comprise a set of transactions, including the record submitted by the authorizing entity. In accordance with block 102, information from at least one of the set of (ledger) transactions (e.g., authorization transaction) may be used to determine the content of the marking.

The content of the marking is cryptographically derived from the corresponding transaction record (or even a few records) in the blockchain ledger, meaning that a cryptographic method has been applied to the information in the blockchain record in order to determine the content for the marking.

In some examples, the content of the marking comprises a signature of the record itself (e.g., the authorization record). In some examples, the cryptographic method comprises a cryptographic hashing function, a one-way function, or the like. The cryptographic method may take, as its input, the information from the blockchain ledger record, and output the content for the marking.

Thus, ‘determining’ the cryptographically-derived content may refer to the process of the manufacturing apparatus manager performing the cryptographic method to obtain the content for marking, or may refer to obtaining information from the blockchain ledger that is cryptographically derived (by another entity) from the blockchain ledger.

The content may provide a cryptographic link between a created object (comprising the content in its marking) and the blockchain ledger since the content is itself cryptographically derived from the blockchain ledger. It may be possible to verify that an object created with the marking content was authorized by the blockchain platform (e.g., the object was created by an authorized entity) based on the cryptographic link between the blockchain ledger and the created object.

In addition to the cryptographically-derived content based on a blockchain ledger, the marking may also include additional content that is not cryptographically derived from a blockchain ledger. In an example, there may be: (1) a ledger record (e.g., the authorization record), (2) other content ‘A’ and (3) other content ‘B’. The content from (1) and (2) may be combined and used as an input for cryptographically deriving the marking content. This cryptographically derived content (derived from (1) and (2)) may be combined with the content from (3) to create the entire content for the marking.

Block 102 of the method 100 further comprises determining object creation instructions to create a modified version of the object comprising the marking.

As mentioned above, object creation instructions may be specified for creating a specified object (e.g., defined by a user or information from the blockchain ledger). The design and/or object creation instructions for the specified object may be stored in a database accessible to the manufacturing apparatus manager. By determining the object creation instructions, the method 100 may modify the design and determine object creation instructions based on the modified design so that the object creation instructions are to produce an object with the marking. In an example, a marking is derived and applied to an object by a manufacturing apparatus (e.g., the marking is created as part of the creation/manufacturing of the object). Since the marking is unique to the object that it is applied to, the object (or product) itself may be regarded as a unique ‘physical’ object. The unique physical object may be tracked in the field based on corresponding records in the ledger. In another example, the marking is derived and applied by an earlier trusted device (e.g., an authorized manufacturing apparatus), and then a design with a unique marking may be tracked to an authorized manufacturing apparatus and beyond as a physical object (based on corresponding records in the ledger).

In other words, without determining the instructions to create the modified version, each object created by the manufacturing apparatus according to the same design may be indistinguishable from each other (at least at some resolution). However, the marking associated with each created object may be unique, so that each object can be made in a way that allows the object to be distinguished from other objects, even if they are produced using the same (“blueprint”) design.

The method 100 further comprises, at block 104, causing the manufacturing apparatus to create the modified version of the object according to the determined object creation instructions (i.e., and the derived marking).

Thus, the manufacturing apparatus (which was authorized by the authorizing entity) may be instructed to create the modified version of the object, comprising the unique marking.

In some examples, the method 100 may provide a way to establish a link between a product and a manufacturing parameter such as an identity of a manufacturing apparatus used to create the object. By cryptographically deriving the content for the marking from the blockchain ledger, as well as implementing the blockchain platform, the cryptographic link may be relatively strong to increase confidence that that the product is genuine.

For example, the manufacturing apparatus (and/or manufacturing apparatus manager) may have a cryptographic identity (e.g., in the form of a public key of a key pair). This cryptographic identity may be included into the authorization transaction, as a way of granting rights to a specified manufacturing apparatus (or manager) to manufacture the object. In other words, when a manufacturing apparatus (or manager) requests a license to create an object via a license request (or indeed submits any other transaction request), the transaction request is signed with the private key (i.e., ‘signature key’) of the key pair. The blockchain platform verifies the transaction request is valid (i.e., that it comes from the authorized manufacturing apparatus or manager) by checking that the signature of the transaction request has a corresponding public key in the blockchain ledger (i.e., in the authorization record). Thus, the blockchain platform enforces that the manufacturing apparatus with the correct cryptographic identity can perform the object creation and/or writing of the relevant record to the blockchain ledger. A manufacturing apparatus that is not authorized does not have the correct private key and therefore the blockchain platform cannot verify the unauthorized manufacturing apparatus (and may prohibit the unauthorized manufacturing apparatus from writing records to the ledger and/or creating the object).

Certain examples described herein may provide the ability to control whether or not a specified manufacturing apparatus can be used to create an object. Certain examples described herein may monitor and/or control at least part of the manufacturing process and/or product distribution. Certain examples described herein may provide a way to verify the provenance of a product. In some examples, a customer or distributor of a manufactured part may scan a part mark, which represents location in the blockchain ledger, and use a blockchain client to trace back and recover information about the part. Its provenance may be traced back to a certain (authorized) manufacturing apparatus and/or the original product rights-holder/product designer.

In some examples, the cryptographically-derived marking is to be created in a physical format as part of the object, when generated. In other words, the marking may be intrinsic to the object/product.

In some examples, the blockchain record comprises information for causing the cryptographically-derived marking to be uniquely distinguishable for each object created in accordance with object creation instructions.

The processing circuitry for implementing the determining at block 102 may refer to the same processing device or a set of processors/processing devices for implementing the functionality at block 102. Block 104 (corresponding to causing the manufacturing apparatus to create the modified version of the object) may be implemented by the same or different processing circuitry to the processing circuitry that implements the block 102.

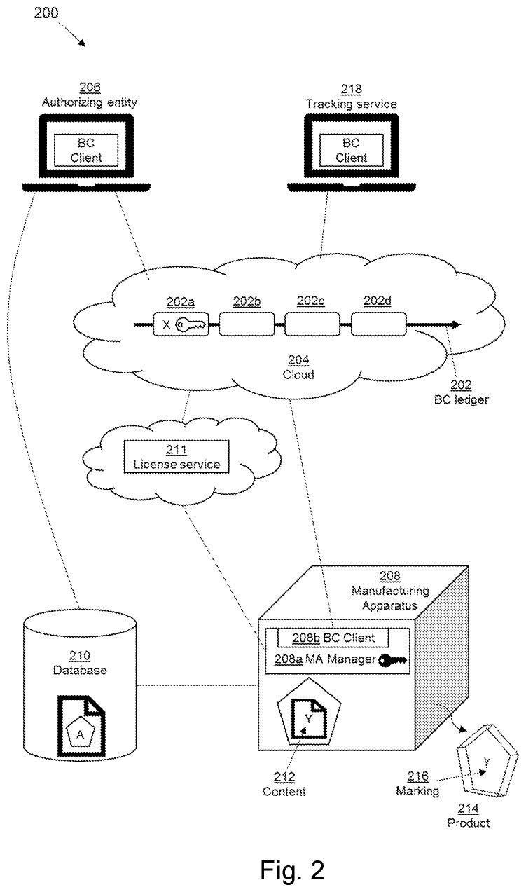

FIG. 2 shows an example system 200 for implementing certain methods (e.g., the method 100 and other methods below), machine-readable media and/or apparatus described herein. The system 200 refers to a blockchain platform which implements certain logic such as a ‘smart contract’ to manage the transactions that take place on a blockchain ledger 202 of a blockchain node (not shown but represented by cloud 204). The cloud 204 may refer to a network of connected blockchain nodes (i.e., blockchain servers) where each blockchain node may store its own copy of the blockchain ledger, providing at least one other blockchain node verifies the transaction.

The system 200 comprises an authorizing entity 206, which comprises a blockchain (‘BC’) client. The authorizing entity 206 submits a record (i.e., record ‘202a’ in FIG. 2) to the blockchain ledger specifying a manufacturing apparatus (i.e., manufacturing apparatus 208 in FIG. 2) that is authorized to produce part ‘A’ (i.e., an ‘object’). Part ‘A’ may be an object design stored in a database 210. In this example, the authorized manufacturing apparatus 208 has a cryptographic identity in the form of a public key which, in this case, is stored on the blockchain ledger 202 at record 202a.

In this example, the manufacturing apparatus 208 implements the functionality of a manufacturing apparatus (‘MA’) manager 208a and interacts with the blockchain ledger 202 via a blockchain client 208b of the MA manager 208a. The public key is part of a key pair comprising a private key and the public key. As indicated in FIG. 2, the private key is held confidentially by the MA manager 208a (or the blockchain client 208b itself) and may be used, by the blockchain client 208b, to sign proposed records for submission to the blockchain ledger 202. The public key stored by the blockchain ledger 202 may be used to validate that the authorized MA manager 208a signed a record.

The blockchain ledger 202 comprises a set of transactions, labelled ‘202a’, ‘202b’, ‘202c’, ‘202d’, which are explained in more detail below. The blockchain ledger 202 may comprise multiple records (including previous records), in addition to the ones shown in FIG. 2. Each subsequent record created in the blockchain ledger 202 may be cryptographically linked to a previous record (e.g., via cryptographic hashing of at least part of the information in the previous record). Thus, the sequence of transactions may define a ‘chain’ of information where each record in the chain is linked to the other records.

In an example scenario, the authorizing entity 206 receives a request from a user (not shown) to indicate which manufacturing apparatus 208 can create part ‘A’. Providing the rules associated with the smart contract are satisfied, record 202a is written to the blockchain ledger 202.

Record 202a may indicate that a new instance of part ‘A’ is authorized to be produced by manufacturing apparatus 208 (and in this case, no other manufacturing apparatus is authorized to produce part ‘A’). In other words, record 202a provides a ‘right’ giving manufacturing apparatus 208 a (potential) license to produce a unique instance of part ‘A’. As explained below, the actual granting of the license may occur in a later transaction.

Various information may be stored in record 202a, as referred to in the examples below. Any selected number and/or combination of the examples below may be stored in record 202a (i.e., in addition to the indication of the authorized manufacturing apparatus 208). Each example refers to an ‘indication’, meaning that the information referred to in each example may or may not be directly stored in the record. For example, the indication may comprise a pointer (e.g., a uniform resource locator (URL), etc.) to a resource such as a database (e.g., database 210 or another database accessible via the cloud) where the information can be retrieved.

In an example, record 202a comprises an indication of a reference to a part identity of a product comprising the object. For example, the indication of the reference may provide the manufacturing apparatus 208 with the information to identity which design it is to create.

In an example, record 202a comprises an indication of a record identification (e.g., a blockchain transaction number, timestamp or other content indicative of the record identity) of a transaction recorded in the blockchain ledger 202. In other words, the record identification may distinguish one record from another record.

In an example, record 202a comprises an indication of an access key for providing access to the object creation instructions (i.e., a design prior to modification with the marking). The access key may be used to unlock a database, for example, to provide access to a set of object designs and/or object creation instructions for retrieval by the manufacturing apparatus 208.

In an example, record 202a comprises an indication of a decryption key for unlocking encrypted content associated with the object. The content associated with the object may comprise at least part of an object design, object creation instructions and/or any other information usable by the manufacturing apparatus 208. In an example, this content may be stored in the database 208 and not released until the decryption key is available. In another example, the encrypted content may be received by the manufacturing apparatus 208 and decrypted in situ, using the decryption key. The decryption key may not be the same key as the signature key from the key pair associated with the identity of the manufacturing apparatus 208. Rather, the decryption key may be another key that is provided for the manufacturing apparatus 208, such as in an example described below.

In an example, if the manufacturing apparatus 208 does not have a decryption key to decrypt the encrypted content associated with the object, the manufacturing apparatus 208 may turn to a licensing service 211 (in a cloud as shown in FIG. 2 or a server (not shown) communicatively coupled to the cloud 204 and the manufacturing apparatus 208) to get the decryption key. The licensing service 211 comprises a blockchain client. Upon receiving a request for a decryption key, the licensing service 211 reads the corresponding ledger record (which comprises a license expiration date) and compares the ledger record with the current date. If the license expired, the licensing service 211 does not release the decryption key. Otherwise, if the license is valid, the licensing service releases the decryption key to the manufacturing apparatus 208.

In an example, prior to releasing the decryption key, the license service 211: (1) performs a query and checks that record 202b is in the ledger 202; and (2) whether the device seeking the decryption key is in fact the authorized manufacturing apparatus 208. If these conditions are satisfied, the content decryption key may then be released encrypted, where the public encryption key of the manufacturing apparatus 208 is used to encrypt the content decryption key. This ensures that the authorized manufacturing apparatus 208 may access the content, by using its corresponding private key, while another non-authorized manufacturing apparatus without such a key cannot access the content.

In another example, the manufacturing apparatus 208 may be trusted to check the license expiration and stop manufacturing if the license has expired.

In another example, if a rogue manufacturing apparatus still proceeds with manufacturing (although such a device may not have a valid key to access the content), despite the license having expired, the manufacturing apparatus 208 is not able to create subsequent records 202b-d to complete and record legitimate manufacturing. For example, business logic implemented by a blockchain smart contract may automatically reject any requests (i.e., they don't satisfy the business logic of being ‘not expired’).

In an example, record 202a comprises an indication of an object creation validity condition defining whether the manufacturing apparatus can create the object. For example, the object creation validity condition may specify under what conditions the manufacturing apparatus 208 may create the object. Example conditions include a specified date or set of dates and/or a specified timeframe within which the manufacturing apparatus 208 may create the object. Further example conditions include any parameters defined by the authorizing entity 206 (e.g., a manufacturing parameter that needs to be met before the object can be created).

In an example, record 202a comprises an indication of a production authorization condition specifying information about an authorized production run. An example production authorization condition may refer to a number of objects authorized to be created as part of a production run. For example, more than one object may be authorized to be created as part of a production run or multiple production runs executed by the authorized manufacturing apparatus 208 when producing a batch or multiple batches of the object(s).

An example procedure implemented by the authorized manufacturing apparatus 208 comprises determining content 212 for the marking (in accordance with block 102 of the method 100). The example procedure further comprises determining the object creation instructions (also in accordance with block 102 of the method 100). In the example procedure, providing a license has been issued and reserved, the authorized manufacturing apparatus 208 creates the object (in accordance with block 104 of the method 100).

In this example procedure, the content 212 is a cryptographic hash/signature/other cryptographic derivation of whole or partial information ‘X’ stored in record 202a. In FIG. 2, the cryptographically-derivation is labeled, ‘Y’). The cryptographically derived information may be further encoded (e.g., Base64) to convert potentially binary information into easily recognizable letters and digits (to be “written” in marking). The content 212 is used to modify the design for part ‘A’ such that the object creation instructions determined by the manufacturing apparatus 208 are unique in that, when created, the object (i.e., product 214) is created with a marking 216 comprising the content 212 (i.e., Y′ in addition to any other information forming part of the marking 216).

Thus, the marking 216 may allow the created product 214 to be distinguished from other, identical, products made in accordance with the design for part ‘A’. In addition, the marking 216 may provide a link to evidence (e.g., in the form of any of records 202b-d) that the product 214 was made by the authorized manufacturing apparatus 208. For example, in response to a user request, a tracking service 218 comprising a blockchain client may query the blockchain ledger 202 using the information in the marking 216 to determine whether or not a candidate product in the supply chain or in the field is genuine or not. In addition, the tracking service 218 may submit records to the blockchain ledger 202 where such a determination is made, to facilitate tracking of genuine and/or non-genuine products.

Further details of the example procedure are described below.

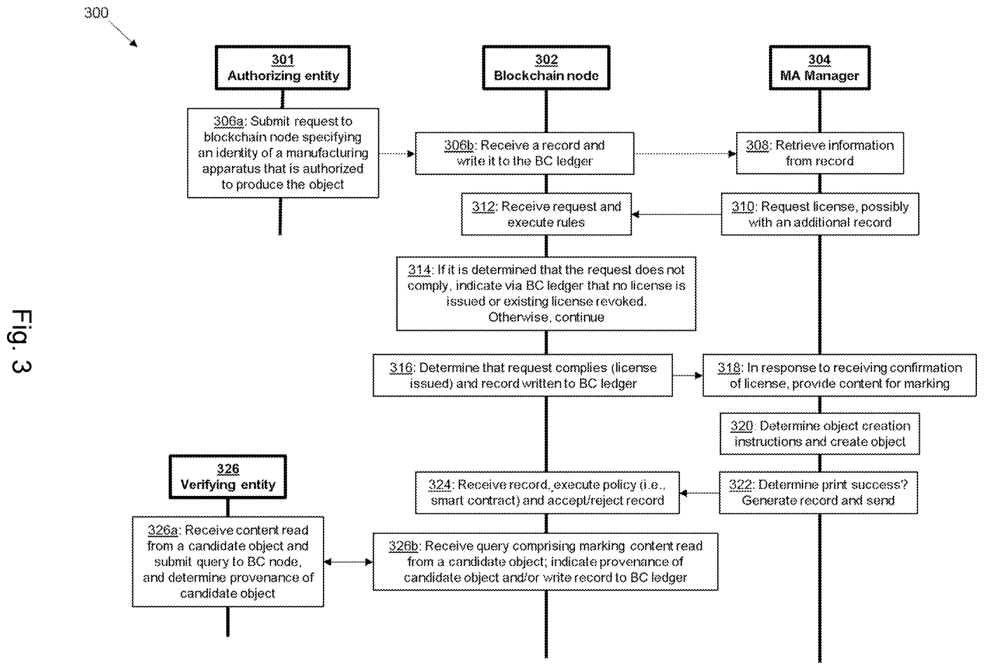

FIG. 3 is a signaling diagram depicting a method 300 implemented by the following entities: an authorizing entity 301 (e.g., 206 in FIG. 2), blockchain node 302, manufacturing apparatus manager 304 and a verifying entity 326 such as a customer/end user. Other entities such as those referred to in FIG. 2 may be involved in implementing the method 300 by sending/receiving data to/from another entity.

FIG. 3 indicates which part of the method 300 is implemented by each of the entities. For example, the blocks under the blockchain node 302 (as also referred to in a separate example below) are implemented at the blockchain node 302 (e.g., in response to the requests from the other entities). The blocks under the manufacturing apparatus (‘MA’) manager 304 (as also referred to in method 100) are implemented by the MA manager 304. Similarly, the blocks under the authorizing entity 301 and the verifying entity 326 are implemented by those entities, respectively.

The method 300 may be a computer-implemented method, i.e., processing circuitry of the blockchain node 302 may implement the parts of the method 300 indicated in FIG. 3 while the processing circuitry of the MA manager 304 may implement the other part of the method 300 indicated in FIG. 3. FIG. 3 also shows an example flow of information between the blockchain node 302 and the MA manager 304 in accordance with the method 300. Reference is made to the features and functionality of system 200 in the description given below. Certain blocks of the method 300 may be implemented in a different order to that shown, or omitted entirely.

At block 306b of the method 300, the blockchain node 302 receives the record 202a from the authorizing entity 301 (i.e., the authorizing entity submits a transaction request 306a specifying an identity of a manufacturing apparatus 208 or manager 304 that is authorized to create the object). Business rules may be enforced as part of a smart contract to determine whether or not a record is to be written to the ledger 202. Thus, if such ‘business’ rules are satisfied, the record 202a is written to the blockchain ledger 202.

At block 308 of the method 300 (in some examples block 308 may not be implemented if the method 300 proceeds to block 310 instead), the MA manager 304 receives an instruction (e.g., from a user) to create part ‘A’ and, in response, retrieves information from the blockchain ledger 202 (e.g., record 202a or another record). The retrieved information may indicate whether or not the manufacturing apparatus 208/MA manager 304 may (if a license is granted) have the right to create the object (or a number of objects). If a license is not granted for a specified manufacturing apparatus 208, there might be no record for this specified manufacturing apparatus in the ledger 202. Thus, if either: (i) no record 202a is available (e.g., if the authorizing entity 301 did not authorize the manufacturing apparatus 208 or MA manager 304); (ii) there is a subsequent record indicating that the manufacturing apparatus 208/MA manager 304 used a license; and/or (iii) there is a record from the authorizing entity 301 revoking a previously-issued license, then the manufacturing apparatus 208/MA manager 304 no longer has the right to create the object.

Assuming the manufacturing apparatus 208 or MA manager 304 has the right to create the object, the MA manager 304 requests a license at block 310 of the method 300. In some cases, the MA manager 304 generates a (e.g., license reservation) record (i.e., record 202b in FIG. 2) for reserving a license to create at least one copy of the object (depending on how many copies the manufacturing apparatus 208 is requested/authorized to create). The record 202b is signed by the BC client 208b and sent to the blockchain node 302.

At block 312 of the method 300, the blockchain node 302 receives the record 202b and executes the rules (e.g., based on a ‘smart contract’), which determine whether or not the submitted record 202b is written to the ledger 202.

As mentioned above, the content 212 for the marking 216 is cryptographically derived from a corresponding authorization record in the ledger 202 (or more than one record in the ledger 202) by a manufacturing apparatus manager 304, which is authorized. Subsequently, when the derived marking is submitted in the record 202b, the analogous derivation is performed by a smart contract before accepting the record 202b, as well as checking that the record 202b has been signed by the authorized manufacturing apparatus 208 or manager 304, whose identity (public key) is included in the record 202a.

At block 314 of the method 300, if a determination is made that the record 202b does not comply with the business rules, no license is issued and/or an existing license is revoked (hence the manufacturing apparatus 208 is denied the possibility to create the object). For example, the business rules may not permit the record 202b to be written to the blockchain ledger 202, thereby indicating (e.g., via non-existence of the record 202b in the ledger) that no license is being provided in response to the request.

Otherwise, at block 316 of the method 300, if the blockchain node 302 determines that the record 202b complies with the business rules, the blockchain ledger 202 is updated to include the record 202b. For example, a ‘smart’ contract implemented by the logic of the blockchain platform enforces that the record 202b can be written to the blockchain ledger 202 if the cryptographic identity of the authorized manufacturing apparatus 208 (i.e., derived from the public key held by record 202a) verifies the digital signature applied to the record 202b by the corresponding private key of the MA manager 304. If the record 202b is written to the blockchain ledger 202, a confirmation of the same is sent to the MA manager 204. The confirmation may comprise a licensing key, as discussed in the following example.

In an example, when the licensing service 211 is contacted for a licensing key (to permit the MA manager 204 to proceed with manufacturing), the licensing service 211 queries the presence of corresponding blockchain records that verify that the MA manager 204 is authorized. If the authorization for a specified manufacturing apparatus 208 or MA manager 304 is not present, or was already used (e.g. the right device already printed these objects), then the licensing key is not released. Otherwise, if the authorization is present, the licensing key is released.

Thus, at block 318 of the method 300, the MA manager 304 receives the confirmation that the license has been issued. In response, the MA manager 304 provides the content 212 for the marking 216 (e.g., such content 212 is determined or has already been determined in accordance with block 102 of the method 100). As mentioned above, the content 212 is cryptographically derived from information in the record 202a (and/or from information in another record in the blockchain ledger 202 that is cryptographically linked to the record 202a) and may be unique to each instance of the created object (i.e., each object has a different marking content even if the object is the same).

In some examples, the content 212 comprises an indication of a signature of the record 202a (i.e., signed by authorizing entity 301). In some examples, the marking 216 comprises a pointer (e.g., a URL) to the cryptographic platform (e.g., so that an entity such as an end user knows where to go to determine whether the object 214 is genuine).

At block 320 of the method 300, the MA manager 304 determines the object creation instructions (e.g., merging the label with the design) and creates the object comprising the marking 216 (e.g., in accordance with at least part of blocks 102 to 104 of the method 100).

At block 322 of the method 300, the MA manager 304 determines whether or not the object has been successfully created, generates a (e.g., success indication) record (i.e., record 202c) to confirm success (or not) and sends the record to the blockchain node 302.

Various errors may occur while generating an object. For example, the object may not pass quality control or there may be an interruption to the object creation process. In such cases, the parts that have been produced with errors may be destroyed, which may imply that a license can be released/re-issued for another object to be created.

If the object has been successfully created, the record 202c may indicate that: (i) the authorized manufacturing apparatus 208 successfully created the object; (ii) the marking of the object comprises content that is cryptographically derived from the blockchain ledger 202; and/or (iii) a license issued for the creation of the object was used.

If the object has not been successfully created, the record 202c may indicate the object creation was not successful.

At block 324 of the method 300, the blockchain node 302 receives the record 202c. Providing the record 202c complies with the business rules (e.g., including that the content 212 of the marking 216 is cryptographically derived from the blockchain ledger 202 and that the object 214 has been successfully created), the record 202c is accepted and written to the blockchain ledger 202 to provide an indication of provenance of the object 214. Thus, a verifiable proof may be generated that confirms that the authorized manufacturing apparatus 208 created the object (e.g., by virtue of the cryptographic identity held in record 202a and the signature applied to record 202c).

In another example, implemented at block 324 of the method 300, the received record 202c may indicate that the object 214 has not been successfully created. The business rules may permit this record 202c be written to the blockchain ledger 202. For example, the MA manager 304 may indicate, via the proposed record 202c, that the object creation failed (so that there isn't an authorized object with the marking in the field). In response to the indication of failure via the proposed record 202c, the business rules may permit a replacement license to be made available for issue.

In another example implemented at block 324 of the method 300, if the proposed record 202c does not comply with the business rules, the record 202c may be rejected. Accordingly, the manufacturer and/or a product distributor may not be able to legitimately sell or distribute the product (subject to verification by a customer accessing the blockchain ledger 202). In some examples, the existence/absence of the record 202c may indicate whether the provenance of a candidate object being tested (e.g., by a customer) can be verified.

If an object comprising the (unique) marking associated with an unsuccessfully-created object is detected in the field, this may indicate an error in the supply/distribution chain. Example scenarios indicating an error may include that the allegedly unsuccessfully-created object was not destroyed by the manufacturer and/or that an unauthorized replica was created using the marking.

At block 326b of the method 300, the blockchain node 302 receives a query 326a submitted by the verifying entity 326 (e.g., a customer/end user or perhaps the tracking service 218 of FIG. 2). The query 326a comprises marking content read from a candidate object (i.e., the verifying entity 326 wishes to determine the provenance of the candidate object). If the marking content is cryptographically associated with information in a record of the blockchain ledger 202 (e.g., via record 202a and/or record 202c), the blockchain node 302 may indicate (e.g., to a verifying entity such as a user, customer and/or the tracking service 218) that the candidate object is assumed to be genuine based on the available information (i.e., the object was authorized to be created and/or the object was successfully created). Otherwise, if the marking content is not associated with information in a record of the blockchain ledger 202, the blockchain node 302 may indicate that the candidate object may not have been authorized (i.e., the candidate object may be counterfeit and/or cloned). In another example scenario, the MA manager 304 may indicate that the object was not successfully created but then proceed to distribute/sell the object. In such a case, this information may be recorded in the blockchain ledger 202 (e.g., via record 202c). As a result, it may be possible to determine that the object is not authorized as well as which entity (e.g., associated with the MA manager 304) made the mistake and allowed the object to the distributed/sold.

In some examples, the query comprises a proposed (e.g., registration) record (e.g., record 202d) comprising the marking content read from the candidate object. Providing the business rules are satisfied, the record 202d is written to the blockchain ledger 202 to register the candidate object as being genuine/authorized. The record 202d may aid in detecting a case where a candidate object has been cloned. For example, if another candidate object is tested and the marking is or is not cryptographically derived from the blockchain ledger 202, the customer/tracking service 218 may take remedial action to deal with the potential clone.

For the avoidance of doubt, when implementing parts of the method 300, the same or a different blockchain node 302 associated with the blockchain ledger 202 may communicate with the MA manager 304. Thus, the method 300 associated with the blockchain node 302 may be implemented by any appropriate blockchain node 302 associated with the blockchain ledger 202 at each block of the method 300.

Although not indicated in the method 300, the tracking service 218 may monitor the blockchain ledger 202 to determine whether certain actions have occurred (e.g., whether or not a license has been issued, whether or not an object has been created, whether or not a product in the field is genuine, etc.).

The methods described below refer to certain example implementations that are related to the method 300.

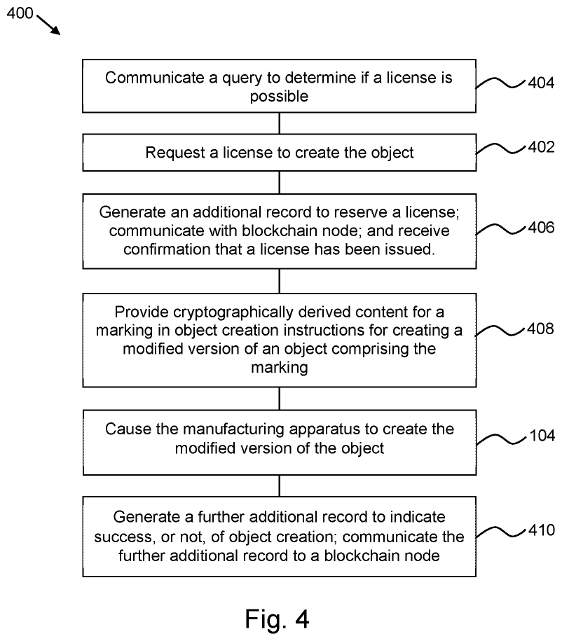

FIG. 4 depicts a flowchart of a method 400, which may be a computer-implemented method, of implementing functionality of a manufacturing apparatus (‘MA’) manager. The method 400 may be implemented by processing circuitry of a manufacturing apparatus manager 208a/304. Thus, the method 400 comprises the method 100 of FIG. 1 and may comprise certain blocks of the method 300. The blocks of the method 400 may be implemented in any appropriate order and in some cases, certain blocks may be omitted entirely. Reference is made to certain blocks of the method 300 in the description given below.

In some examples, the method 400 comprises, at block 402, in response to receiving an object creation request (e.g., a user instruction to create an object), communicating with a blockchain node 302, to request a license to create the object. Block 402 may at least partially implement certain functionality implemented by block 310 of FIG. 3.

In some examples, the method 400 comprises, at block 404, comprising communicating a query (e.g., for sending to the blockchain node 302) to determine if the license is possible prior to requesting the license and/or prior to receiving the object creation request. Block 404 may at least partially implement certain functionality implemented by blocks 308 and/or 310 of FIG. 3.

In some examples, the method 400 comprises, at block 406, generating an additional record (e.g., record 202b) for reserving the license. Block 406 further comprises communicating with the blockchain node 302 to cause the additional record to be written to the blockchain ledger 202. Block 406 may at least partially implement certain functionality implemented by block 310 of FIG. 3. In response to receiving a confirmation that the additional record has been written to the blockchain ledger, the method 400 comprises: providing, at block 408, the cryptographically-derived content for a marking in object creation instructions for creating a modified version of an object comprising the marking (e.g., based on block 102 of the method 100). The method 400 further comprises, at block 104, causing the manufacturing apparatus 208 to create the modified version of the object.

In some examples, the method 400 comprises, at block 410, generating a further additional record (i.e., record 202c) to indicate whether or not the object has been successfully created in response to determining whether the object has been successfully created. Block 410 further comprises communicating with a blockchain node 302 (e.g., any blockchain node 302) to request that the further additional record be written to the blockchain ledger 202. Block 410 may at least partially implement certain functionality implemented by block 322 of FIG. 3.

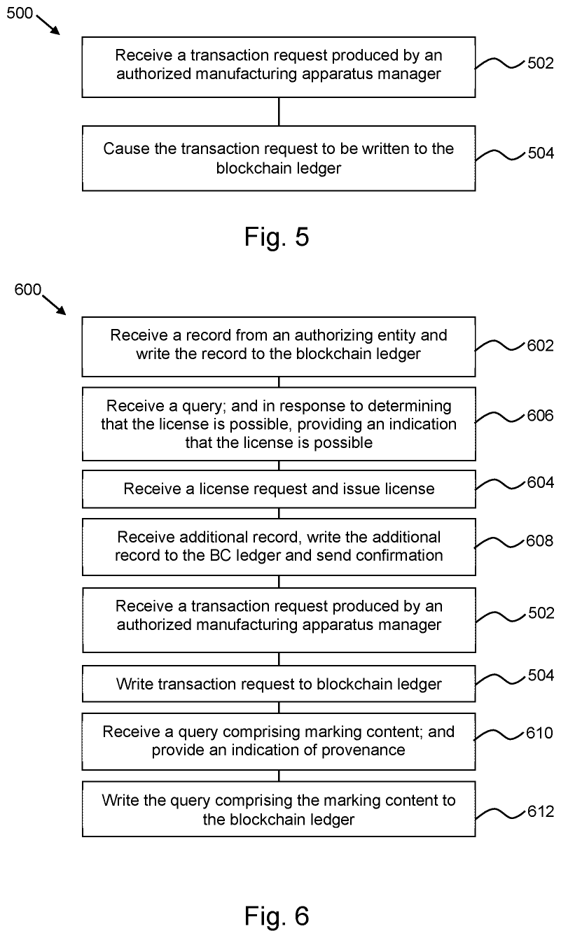

FIG. 5 depicts a flowchart of a method 500, which may be a computer-implemented method, of implementing functionality of a blockchain node. The method 500 may be implemented by processing circuitry of a blockchain node 302. Thus, the method 500 may comprise certain blocks of the method 300. Reference is made to certain blocks of the method 300 in the description given below.

The method 500 comprises, at block 502, receiving a transaction request produced by an authorized MA manager 208a/304. The transaction request (e.g., comprising proposed record 202c) indicates a marking content (e.g., content 212) produced by the authorized MA manager 208a/304. The marking content is cryptographically derived from a record (e.g., record 202a) of a blockchain ledger 202 held by the blockchain node 302. The record 202a authorizes manufacturing of an object by a manufacturing apparatus 208 associated with the authorized MA manager 208a. Block 502 may at least partially implement certain functionality of block 324 of the method 300.

In response to determining that the transaction request complies with a blockchain ledger policy (e.g., rules implementing a blockchain smart contract), the method comprises causing, at block 504, the transaction request to be written to the blockchain ledger 202. Block 504 may at least partially implement certain functionality of block 324 of the method 300.

FIG. 6 depicts a flowchart of a method 600, which may be a computer-implemented method, of implementing functionality of a blockchain node. The method 600 may be implemented by processing circuitry of a blockchain node 302. Thus, the method 600 may comprise certain blocks of the method 300 (and the method 600 further comprises the blocks 502 to 504 of the method 500). The blocks of the method 600 may be implemented in any appropriate order and in some cases, certain blocks may be omitted entirely. Reference is made to certain blocks of the method 300 in the description given below.

In some examples, prior to receiving the transaction request, the method 600 comprises, at block 602, receiving the record from an authorizing entity and writing the record (e.g., record 202a) to the blockchain ledger 202. Block 602 may at least partially implement certain functionality of block 306b of the method 300.

In some examples, the method 600 comprises, at block 604, receiving (e.g., from the authorized MA manager 208a/304) a license request for a license to create the object. In response to determining that the license request complies with the blockchain ledger policy, block 604 further comprises issuing the license. Block 604 may at least partially implement certain functionality of at least one of blocks 312, 314 and/or 316 of the method 300.

In some examples, the method 600 comprises, at block 606, receiving, from the authorized MA manager 208a/304, a query to determine if the license is possible prior to receiving the license request; and in response to determining that the license is possible, providing an indication that the license is possible. Block 606 may at least partially implement certain functionality of at least one of blocks 312, 314 and/or 316 of the method 300.

In some examples, the method 600 comprises, at block 608, receiving, from the authorized manufacturing apparatus manager 208a, an additional record (e.g., record 202b) for reserving the license. In response to determining that the license is available, block 608 further comprises writing the additional record to the blockchain ledger 202. Block 608 further comprises sending, to the authorized MA manager 208a/304, a confirmation that the additional record has been written to the blockchain ledger 202. Block 608 may at least partially implement certain functionality of at least one of blocks 312, 314 and/or 316 of the method 300. In response, the authorized MA manager 208a/304 may generate and submit the transaction request referred to in blocks 502 to 504 of the methods 500/600.

In some examples, the method 600 comprises, at block 610, receiving a query (e.g., a proposed record 202d) comprising marking content read from a candidate object (e.g., a candidate object may be defined as an object in the field that a user/customer is testing). Block 610 further comprises providing an indication of a provenance of the candidate object based on (i) whether or not the marking content read from the candidate object is cryptographically derived from the record (e.g., record 202a) of the blockchain ledger 202 held by the blockchain node 302 and/or (ii) an indication that the candidate object was either successfully or unsuccessfully created (e.g., via record 202c). Block 610 may at least partially implement certain functionality associated with block 326 of the method 300.

In some examples, the method 600 comprises, at block 612, writing the query (e.g., record 202d) to the blockchain ledger in response to determining that the candidate object is cryptographically derived from the record of the blockchain ledger 202 held by the blockchain node 302 and/or that the candidate object was successfully created. Block 612 may at least partially implement certain functionality of block 326 of the method 300.

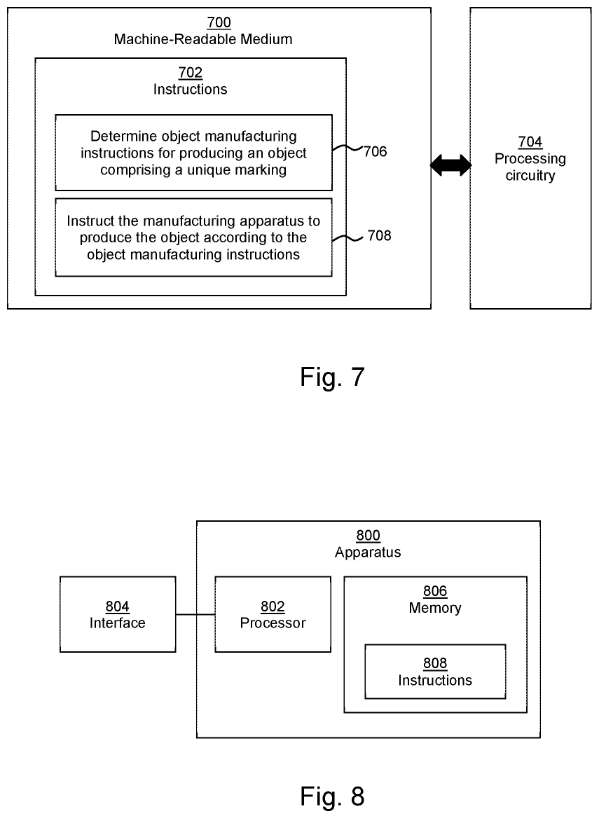

FIG. 7 schematically illustrates an example machine-readable medium 700 (e.g., a tangible machine-readable medium) which stores instructions 702 which, when executed by processing circuitry 704 (e.g., at least one processor), cause the processing circuitry 704 to carry out certain methods described herein (e.g., method 100, certain blocks of method 300 and/or method 400). The machine-readable medium 700 may implement the functionality of the manufacturing apparatus manager 208a/304. In some examples, the instructions 702 comprise instructions to cause the processing circuitry 704 to implement the functionality of blocks 102 to 104 of the method 100. In this example, the instructions 702 may implement certain functionality that is similar to at least some of the blocks 102 to 104 of the method 100.

In this example, the instructions 702 comprise instructions 706 to determine object manufacturing instructions (e.g., ‘object creation instructions’) for producing an object comprising a unique marking. The unique marking comprises content (e.g., content 212) that is cryptographically derived from a blockchain ledger 202. The blockchain ledger 202 comprises a record 202a indicative of a manufacturing apparatus 208 having permission to produce the object. Instructions 706 may provide similar functionality to block 102 of the method 100.

The instructions 702 further comprise instructions 708 to instruct the manufacturing apparatus 208 to produce the object according to the object manufacturing instructions. Instructions 708 may provide similar functionality to block 104 of the method 100.

FIG. 8 is a schematic illustration of an example apparatus 800 for implementing or at least partially facilitating certain methods or machine-readable media described herein (e.g., methods 100, 300, 400 and/or machine-readable medium 700). Thus, the apparatus 800 may implement certain functionality of the manufacturing apparatus manager 208a/304. The apparatus 800 comprises at least one processor 802 communicatively coupled to an interface 804 (e.g., implemented by a blockchain client) for communicating with the blockchain node 302. The apparatus 800 further comprises a tangible machine-readable medium 806 (e.g., ‘memory’) storing instructions 808 readable and executable by the at least one processor 802 to perform a method according to various examples described herein (e.g., methods 100, 300, 400 and/or machine-readable medium 700).

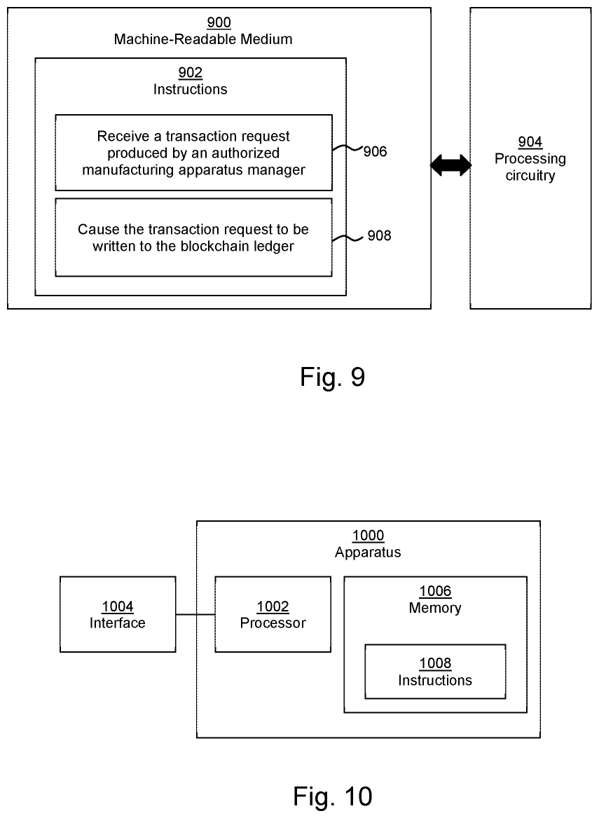

FIG. 9 schematically illustrates an example machine-readable medium 900 (e.g., a tangible machine-readable medium) which stores instructions 902 which, when executed by processing circuitry 904 (e.g., at least one processor), cause the processing circuitry 904 to carry out certain methods described herein (e.g., certain blocks of method 300, method 500 and/or method 600). The machine-readable medium 900 may implement the functionality of the blockchain node 302. In some examples, the instructions 902 comprise instructions to cause the processing circuitry 904 to implement the functionality of any of the blocks referred to in certain blocks of method 300, method 500 and/or method 600. In this example, the instructions 902 implement functionality corresponding to method 500. That is, the instructions 902 comprise instructions 906 to implement the functionality of block 502 of the method 500. The instructions 902 further comprise instructions 908 to implement the functionality of block 504 of the method 500.

FIG. 10 is a schematic illustration of an example apparatus 1000 for implementing or at least partially facilitating certain methods or machine-readable media described herein (e.g., certain blocks of method 300, method 500 and/or method 600). Thus, the apparatus 1000 may implement certain functionality of the blockchain node 302. The apparatus 1000 comprises at least one processor 1002 communicatively coupled to an interface 1004 (e.g., implemented by a blockchain client) for communicating with the MA manager 304. The apparatus 1000 further comprises a tangible machine-readable medium 1006 (e.g., ‘memory’) storing instructions 1008 readable and executable by the at least one processor 1002 to perform a method according to various examples described herein (e.g., certain blocks of method 300, method 500 and/or method 600).

Any of the blocks, nodes, instructions or modules described in relation to the figures may be combined with, implement the functionality of or replace any of the blocks, nodes, instructions or modules described in relation to any other of the figures. For example, methods may be implemented as machine-readable media or apparatus, machine-readable media may be implemented as methods or apparatus, and apparatus may be implemented as machine-readable media or methods. Further, any of the functionality described in relation to any one of a method, machine readable medium or apparatus described herein may be implemented in any other one of the method, machine readable medium or apparatus described herein.

Examples in the present disclosure can be provided as methods, systems or as a combination of machine-readable instructions and processing circuitry. Such machine-readable instructions may be included on a non-transitory machine (for example, computer) readable storage medium (including but not limited to disc storage, CD-ROM, optical storage, etc.) having computer readable program codes therein or thereon.

The present disclosure is described with reference to flow charts and block diagrams of the method, devices and systems according to examples of the present disclosure. Although the flow charts described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing circuitry, or a module thereof, may execute the machine-readable instructions. Thus, functional nodes, modules or apparatus of the system 200 (for example, the blockchain node 302 and/or MA manager 208a/304) and other devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer program product, the computer program product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the scope of the present disclosure. It is intended, therefore, that the method, apparatus and related aspects be limited by the scope of the following claims and their equivalents. It should be noted that the above-mentioned examples illustrate rather than limit what is described herein, and that many implementations may be designed without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method, comprising:
determining, using processing circuitry:
a cryptographically-derived content for a marking based on a blockchain ledger, where the blockchain ledger comprises a record authorizing a manufacturing apparatus to create an object; and
object creation instructions to create a modified version of the object comprising the marking; and
causing the manufacturing apparatus to create the modified version of the object according to the determined object creation instructions.

2. The method of claim 1, where the record authorizing the manufacturing apparatus comprises a cryptographic identity of the manufacturing apparatus.

3. The method of claim 1, comprising:
in response to receiving an object creation request, communicating, by a manufacturing apparatus manager, with a blockchain node, to request a license to create the object.

4. The method of claim 3, comprising communicating, by the manufacturing apparatus manager, a query to determine if the license is possible prior to requesting the license and/or prior to receiving the object creation request.

5. The method of claim 3, comprising:
generating an additional record for reserving the license;
communicating with the blockchain node to cause the additional record to be written to the blockchain ledger; and
in response to receiving a confirmation that the additional record has been written to the blockchain ledger:
determining the cryptographically-derived content for the marking;
determining the object creation instructions; and/or
causing the manufacturing apparatus to create the modified version of the object.

6. The method of claim 5, comprising:
in response to determining whether the object has been successfully created, generating a further additional record to indicate whether or not the object has been successfully created; and
communicating with a blockchain node to request that the further additional record be written to the blockchain ledger.

7. The method of claim 1, where the record comprises an indication of:
(a) a reference to a part identity of a product comprising the object;
(b) a record identification of a transaction recorded in the blockchain ledger;
(c) an access key for providing access to the object creation instructions;
(d) a decryption key for unlocking encrypted content associated with the object;
(e) an object creation validity condition defining whether the manufacturing apparatus can create the object; and/or
(f) a production authorization condition specifying information about an authorized production run.

8. A tangible machine-readable medium storing instructions which, when executed by processing circuitry, causes the processing circuitry to:
determine object manufacturing instructions for producing an object comprising a unique marking, where the unique marking comprises content that is cryptographically derived from a blockchain ledger, where the blockchain ledger comprises a record indicative of a manufacturing apparatus having permission to produce the object; and
instruct the manufacturing apparatus to produce the object according to the object manufacturing instructions.

9. A method, comprising:
receiving, by a blockchain node comprising processing circuitry, a transaction request produced by an authorized manufacturing apparatus manager, where:
the transaction request indicates a marking content produced by the authorized manufacturing apparatus manager;
the marking content is cryptographically derived from a record of a blockchain ledger held by the blockchain node; and
the record authorizes manufacturing of an object by a manufacturing apparatus associated with the authorized manufacturing apparatus manager; and
in response to determining that the transaction request complies with a blockchain ledger policy, causing the transaction request to be written to the blockchain ledger.

10. The method of claim 9, comprising:
receiving a query comprising marking content read from a candidate object; and
providing an indication of a provenance of the candidate object based on whether or not the marking content read from the candidate object is cryptographically derived from the record of the blockchain ledger held by the blockchain node.

11. The method of claim 10, comprising writing the query to the blockchain ledger in response to determining that the candidate object is cryptographically derived from the record of the blockchain ledger held by the blockchain node.

12. The method of claim 9, comprising:
receiving, from the authorized manufacturing apparatus manager, a license request for a license to create the object; and
in response to determining that the license request complies with the blockchain ledger policy, issuing the license.

13. The method of claim 12, comprising:
receiving, from the authorized manufacturing apparatus manager, a query to determine if the license is possible prior to receiving the license request; and
in response to determining that the license is possible, providing an indication that the license is possible.

14. The method of claim 12, comprising:
receiving, from the authorized manufacturing apparatus manager, an additional record for reserving the license;
in response to determining that the license is available, writing the additional record to the blockchain ledger; and
sending, to the authorized manufacturing apparatus manager, a confirmation that the additional record has been written to the blockchain ledger.

15. The method of claim 9, comprising:
prior to receiving the transaction request, receiving the record from an authorizing entity and writing the record to the blockchain ledger.
